(19) United States
(12) Patent Application Publication
(10) Pub. No.: US 2013/0188918 A1
(43) Pub. Date: Jul. 25, 2013

(54) Double Cladding Silicon-on-Insulator Optical Structure

(71) Applicant: TERAXION, INC., Quebec (CA)

(72) Inventors: Yves Painchaud, Quebec (CA); François Pelletier, Saint-Augustin-De-Desmaures (CA)

(73) Assignee: TERAXION, INC., Quebec (CA)

(21) Appl. No.: 13/749,165

(22) Filed: Jan. 24, 2013

Related U.S. Application Data
(60) Provisional application No. 61/589,994, filed on Jan. 24, 2012.

(51) Int. Cl. G02B 6/036

(52) U.S. Cl. CPC G02B 6/036; G02B 6/03694
USPC 385/130; 427/163.2

(57) ABSTRACT

A SOI optical structure is provided, including a succession of a substrate, insulator layer, patterned silicon layer and first and second cladding layer. In one embodiment the substrate is made of silicon, the insulator layer and first cladding are made of silicon oxide, and the second cladding layer is made of silicon nitride. The double cladding configuration provides both light confinement within the waveguides defined by the patterned silicon layer and optical isolation, for example from metal absorption when the optical structure is metallized. The double cladding configuration may also help reducing stresses within the optical structure.

### CROSS-REFERENCE TO RELATED APPLICATION

This application claims the benefit under 35 U.S.C. §119(e) of U.S. Provisional Application Ser. No. 61/589,994, entitled “Double Cladding Silicon-on-Insulator Optical Structure,” filed Jan. 24, 2012, the entire disclosure of which is hereby expressly incorporated by reference herein.

### FIELD OF THE INVENTION

The present invention relates to the field of integrated photonics. In particular, it concerns a double cladding design for silicon-on-insulator (SOI) optical structures that provides optical isolation while mitigating optical perturbations due to stress.

### BACKGROUND

Compared to other material combinations for photonic integration, silicon-on-insulator is particularly attractive, as it can provide very compact optical circuits. Such optical circuits are usually made by etching part of a thin layer of silicon (typically 220 nm) to define waveguides, the silicon layer lying on top of a buried silicon oxide insulator layer (typically 1 to 3 μm), itself extending on top of a thick silicon substrate. The presence of the buried silicon oxide insulator layer within the wafer can allow an ultrahigh confinement of light within the waveguides of the optical circuits.

FIG. 1 (PRIOR ART) shows the structure of a typical SOI optical structure 20. It is based on a multilayer structure including a silicon (Si) substrate layer 26, a buried silicon oxide (SiO₂) layer 24 and a silicon layer 22. The silicon layer 22 is fully etched down to the buried silicon oxide layer 24 according to a pattern leaving non-etched regions 28. One or more of the non-etched regions 28 forms a waveguide 30, which can have a typical width of about 500 nm for a proper singlemode operation. Light propagating in the waveguide 30 is highly confined as a result of the high index contrast between the waveguide material (n_{Si}=3.5) and the surrounding environment, that is silicon oxide at the bottom (n_{SiO2}=1.45) and air on both sides and top (nₐᵢᵣ=1.0).

Referring to FIG. 2 (PRIOR ART), it is of common use to put a silicon oxide cladding 32 on top of the silicon layer 22, for a better isolation from the outside. In particular, the cladding 32 is mandatory when a metallized layer 51 is required on top of the optical structure 20. Typically, the light propagating through such an optical structure is only weakly affected by a material not directly next to the waveguiding material but located far from it (for example farther than about 200-300 nm), except when it is an absorbing material such as a metal. In that case, a greater distance (farther than about 600 nm) is required between the absorbing material and the waveguiding material. Accordingly, a cladding thickness greater than about 600 nm is often preferable to avoid excess losses due to metal absorption when a metallization layer is deposited on top of the cladding 32.

Silicon oxide is a widely used material for the cladding 32 as its refractive index is low enough to preserve the high index contrast necessary for a high light confinement within the waveguide 30. Silicon oxide is also highly compatible with standard manufacturing processes such as CMOS. However, its thermal expansion coefficient is significantly different than the one of silicon, resulting in significant stress in the cladding 32 and waveguide 30. Apart from the thermal expansion mismatch, intrinsic stress can also be high depending on the deposition technique.

There remains a need for SOI optical structures having improved waveguiding properties.

### SUMMARY

In accordance with an aspect of the invention, there is provided a silicon-on-insulator optical structure which includes, successively:
a substrate layer;
an insulator layer;
a patterned silicon layer defining a waveguiding structure;
a first cladding layer having a refractive index and a thickness providing light confinement within the waveguiding structure;
a second cladding layer optically isolating the waveguiding structure and made of a material different than a material of the first cladding layer; and
a metallized top layer.

Preferably, the thicknesses of the first and second claddings are selected to obtain a satisfactory compromise between light confinement properties and optical isolation of the waveguiding structure. The thickness of the first cladding is preferably selected as small as possible while maintaining suitable confinement of light within the waveguiding structure.

In accordance with another aspect of the invention, there is also provided silicon-on-insulator optical structure, comprising, successively:
a silicon substrate layer;
a silicon oxide insulator layer;
a patterned silicon layer defining a waveguiding structure;
a first cladding layer having a refractive index and a thickness providing light confinement within the waveguiding structure; and
a second cladding layer made of a material having a thickness and mechanical properties reducing stresses in the silicon-on-insulator optical structure.

According to another aspect of the present invention, there is also provided a silicon-on-insulator optical structure which includes, successively, a silicon substrate layer, a silicon oxide insulator layer, a patterned silicon layer defining a waveguiding structure, a silicon oxide first cladding layer providing light confinement within the waveguiding structure, and a silicon nitride second cladding layer.

Preferably, the second cladding layer optically isolates the waveguiding structure and reduces stresses in the optical structure.

According to yet another aspect of the invention, there is further provided a method for making a silicon-on-insulator optical structure, comprising:
a) providing a base comprising, successively, a silicon substrate layer, a silicon oxide insulator layer and a silicon top layer over;
b) patterning the silicon to layer to define a waveguiding structure;
c) depositing a first cladding layer over the patterned silicon layer, the first cladding layer having a refractive index and a thickness providing light confinement within the waveguiding structure; and
d) depositing a second cladding layer over the first cladding layer, the second cladding layer optically isolating the waveguiding structure and having a thickness and mechanical properties reducing compressive stresses in said silicon-on-insulator optical structure.

Other features and advantages of the present invention will be better understood upon a reading of embodiments thereof, with reference to the appended drawings.

### BRIEF DESCRIPTION OF THE DRAWINGS

FIG. 1 (PRIOR ART) is a schematic cross-sectional view of a SOI optical structure according to prior art.

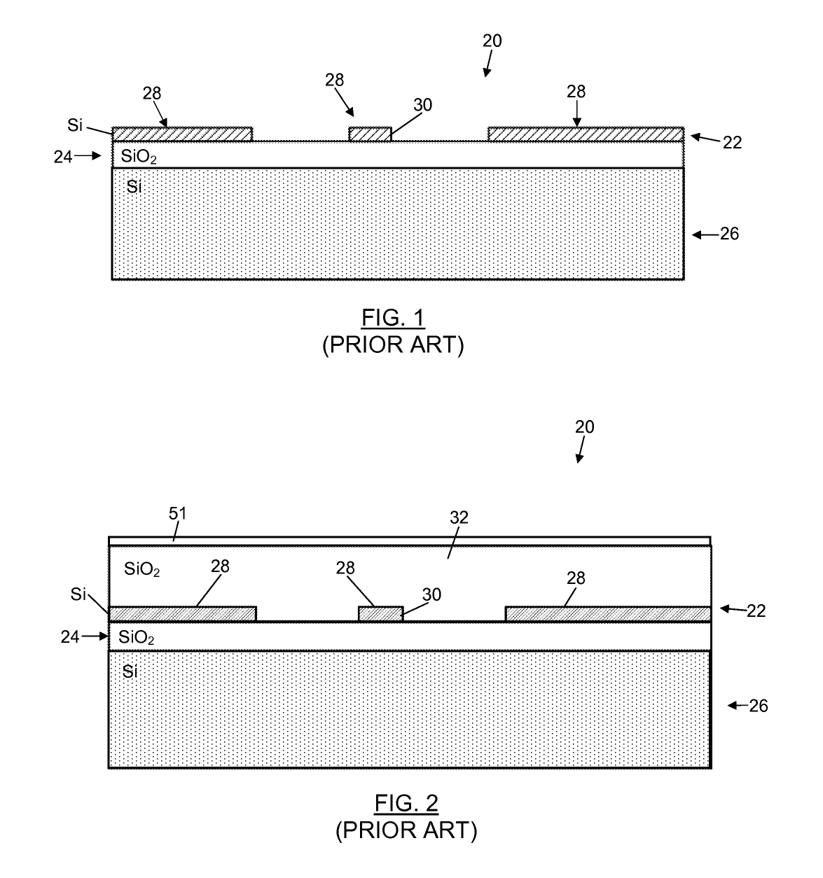

FIG. 2 (PRIOR ART) is a schematic cross-sectional view of a SOI optical structure according to prior art, having a silicon oxide cladding.

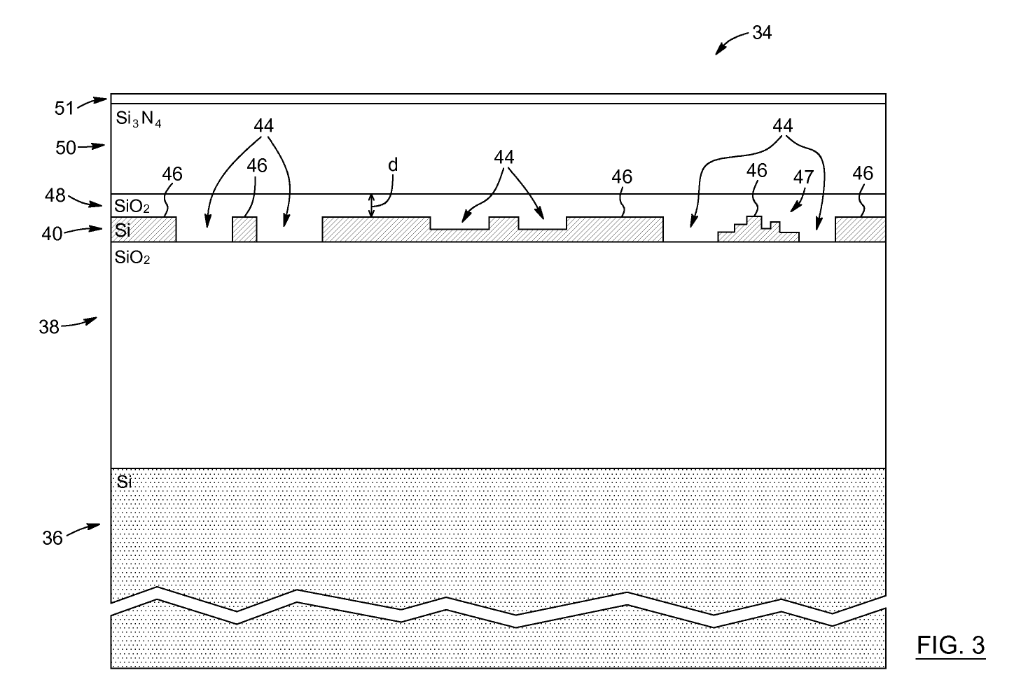

FIG. 3 is a schematic cross-sectional view of a SOI optical structure according to an embodiment of the invention.

FIG. 4 is a graph showing the quadrature phase in 90° hybrids based on the optical structures without a cladding (sample A) and with silicon cladding of different thicknesses (samples B and C).

FIG. 5A to 5D are graphs showing the measured quadrature phase for six samples at different steps of a method of making an optical structure according to an embodiment of the invention: without any cladding (FIG. 5A); after the deposition of 200 nm of silicon oxide first cladding (FIG. 5B); after the deposition of 400 nm silicon nitride second cladding (FIG. 5C); and after the deposition of an additional 400 nm of silicon nitride (FIG. 5D).

FIG. 6 is a top view of a MMI coupler as an example of an optical structure embodying the invention.

### DESCRIPTION OF EMBODIMENTS OF THE INVENTION

In accordance with one aspect of the invention, there is provided a SOI optical structure.

As one skilled in the art will readily understand, the SOI optical structure may be embodied by any integrated circuit or portion of an integrated circuit based on SOI technology. As its name indicates, a Silicon-On-Insulator device includes an insulator layer, typically silicon oxide (SiO₂), on which extends a patterned silicon layer. The patterned silicon layer may define one or more waveguides, as required by a given circuit design.

In one application, a SOI optical structure according to an embodiment of the present invention can be of particular use as a MultiMode Interference (MMI) coupler. MMI couplers can be used for various applications such as telecommunications, instrumentation, signal processing and optical sensors. SOI optical structures according to embodiments of the invention can however have different functions than a MMI coupler, such as for example arrayed waveguide gratings (AWG), direction couplers, Y branches and star couplers.

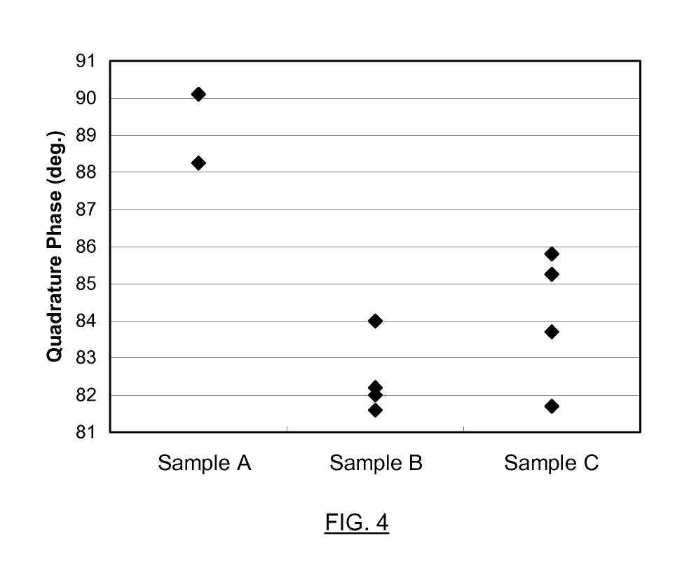

Referring to FIG. 3, there is shown a 501 optical structure 34 according to an embodiment of the invention. The SOI optical structure 34 includes a succession of layers extending one over the other. It will be readily understood that although the layers of the SOI optical structure 34 are shown herein as a schematized cross section defining a simple rectangular pattern, in practice optical structures embodying the invention may have various shapes and need not be coextensive over their entire surface. Furthermore, it will be understood that the relative thicknesses of the layers of the SOI optical structures illustrated herein are not drawn to scale, some dimensions having been exaggerated for clarity.

The SOI optical structure 34 of FIG. 3 first includes a silicon (Si) substrate layer 36, a silicon oxide (SiO₂) insulator layer 38 extending over the substrate layer 36 and a silicon layer 40 extending over the silicon oxide layer 38 and patterned to define a waveguiding structure 42. The waveguide structure may form one or more planar waveguides, which may be of various types such, but not limited to, slab waveguides, strip waveguides, ridge waveguides and rib waveguides. As will be readily understood by one skilled in the art, the waveguide structure 42 is typically formed by etching the silicon layer 40 to form a plurality of corrugations including raised 46 and void regions 44. By virtue of their high index contrast with their surroundings, at least some of the raised 46 define the waveguiding structure 42. The void regions 44 may be formed by etching the silicon layer 22 partially or fully down to the insulator layer 38. In some embodiments one or more raised region may have a more complex multilevel profile 47, such as illustrated in FIG. 3 by way of example only. The overall thickness of the silicon layer 40 and the etching pattern are preferably selected in view of the desired dimensions of the waveguiding structure 42.

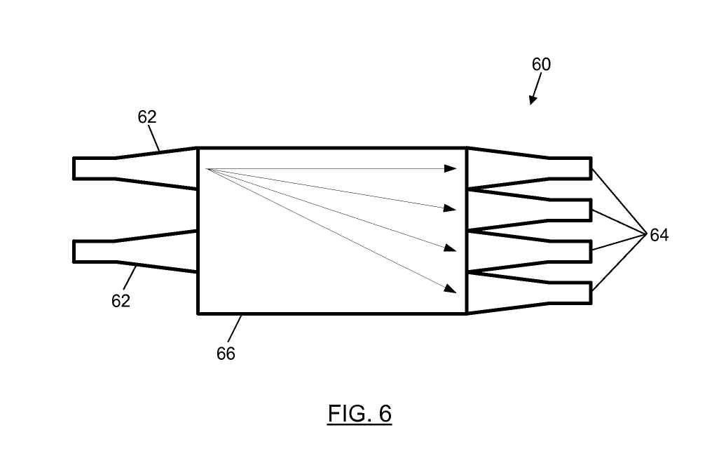

In one embodiment, the waveguide structure may define a plurality of waveguides forming a multimode interference coupler (MMI coupler). By way of example, a top view of a typical 2×4 MMI coupler 60 is shown in FIG. 6. It includes a pair of input waveguides 62, four output waveguides 64 and a MMI coupling region 66 splitting light from each input waveguides 62 among all of the output waveguides 64 according to a self-imaging process.

Multimode interference (MMI) couplers are widely used in integrated photonics. A MMI coupler is a multimode waveguide section between sets of input and output waveguides, which are typically singlemode. They are used to split, combine or mix optical signals. 2×4 MMI couplers are of particular interest, as they provide the functionality of a 90° optical hybrid mixer, a key component of a coherent receiver. A MMI coupler performs the splitting of the input optical signals among 4 output waveguides and provides, at each output, a mix of the two input optical signals with their relative phases being different for each of the outputs. By design, these four relative phases are usually in quadrature, as required for the hybrid mixer functionality. A perfect quadrature is obtained assuming that the MMI coupler operates in a paraxial regime and assuming that the multimode section is uniform. Such structures can greatly benefit from the advantages of SOI integrated circuits, if they can meet the corresponding performance requirements.

The SOI optical structure 34 next includes a first cladding layer 48 extending over the silicon layer 40. The first cladding layer 48 therefore fills the void regions 44 of the silicon layer 40 and covers the overall void and raised regions 44 and 46 of the silicon layer 40. The first cladding layer 48 has a refractive index and a thickness providing light confinement within the waveguiding structure, that is, ensure sufficient refractive index contrast between the silicon waveguiding structure 42 and the first cladding layer 48 in order to provide a high mode confinement for the purposes of a target application. As such, the first cladding layer is preferably made of a material having a low refractive index. One skilled in the art will readily understand that by referring to a “low” refractive index, it is understood that the material of the first cladding layer 48 has a refractive index which is small enough with respect to the refractive index of silicon (n_{Si}=3.5) for providing a suitable light confinement within the waveguiding structures 42. In the illustrated embodiment, and by way of example, the first cladding layer 48 is made of silicon oxide, which has a refractive index n_{SiO2} of 1.45.

It will be further understood that the expression “light confinement” refers to the guiding of one or more light mode within the waveguiding structure such that the light in the travelling mode or modes remains substantially within the silicon waveguide. Of course, as one skilled in the art will readily understand, guided modes present an evanescent field which extends partially in the cladding surrounding the waveguide. the presence of such an evanescent field being considered as within the definition of light confinement. However, interaction of the evanescent field with other components of the optical structure may create losses of light which need to be mitigated, as will be further explained below.

The thickness d of the first cladding layer 48 extending above the raised regions 46 is also a factor which impacts light confinement within the waveguiding structures 42. Increasing the thickness of the first cladding layer may improve the light confinement properties. However, it can be advantageous to have a first cladding layer 48 as thin as possible to minimize stress therein, resulting from the deposition process. In fact, a compressive stress is induced during this process, caused by both the intrinsic chemical structure mismatch between the silicon oxide and the substrate, and temperature-induced variations caused by the coefficient of thermal expansion (CTE) mismatch when the cool down of the substrate occurs (for example from 400° C., at which the silicon oxide can be deposited, down to ambient temperature). Silicon oxide has a coefficient of thermal expansion (5.4×10⁻⁷ K⁻¹) different than the coefficient of thermal expansion of silicon (3.6×10⁻⁶ K⁻¹). The global resulting stress is normally in the range of 100-400 MPa compressive, with a typical value of 300 MPa compressive. The stressed silicon oxide cladding layer transmits its stress to the substrate driven by its stiffness. The stiffness is dictated by the layer thickness, thus from a mechanical standpoint, the thickness of the first cladding layer should be kept minimal to insure that the stress is not transferred to the substrate. In some embodiments, the thickness of the first cladding layer is therefore selected so as to be as thin as possible so that the stress it induces is small enough to keep the optical behavior nearly unaffected, while still be thick enough to preserve a high light confinement. In some embodiments, a thickness of the same order of magnitude as that of the silicon layer, for example in the range of 200 to 300 nm, was found to provide an acceptable compromise.

The SOI optical structure 34 next includes a second cladding layer 50 extending over the first cladding layer 48.

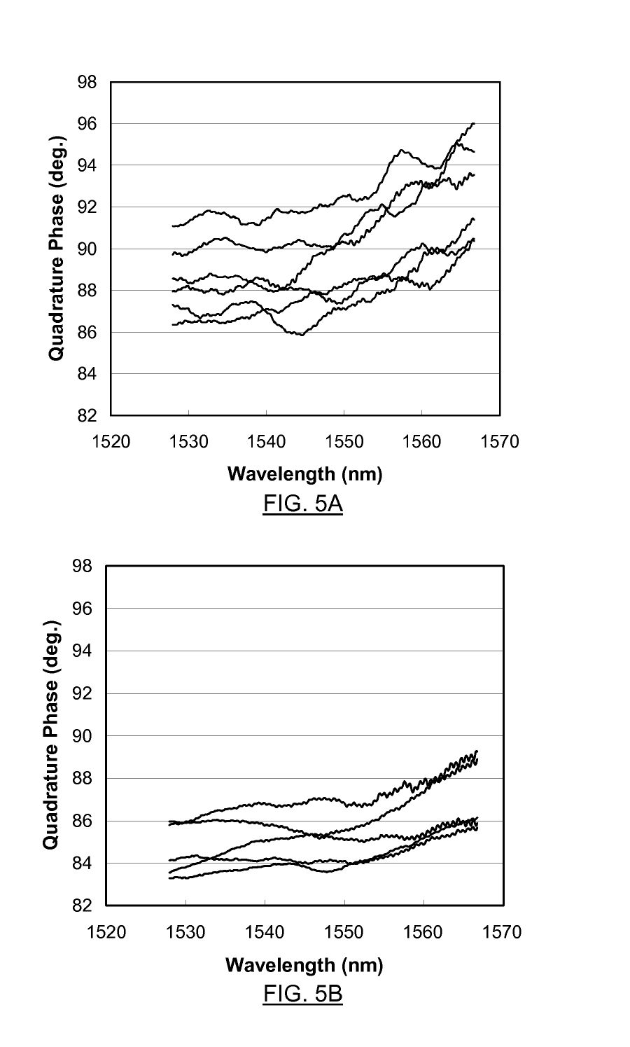

In one embodiment, the second cladding layer 50 is preferably of a sufficient thickness to optically isolate the waveguiding structure 42 from external perturbations. For example, in embodiments where a metallized top layer 51 is provided over the second cladding layer 50, the second cladding layer can prevent attenuation of the mode propagating through the guide due to the mode field that would evanescently extent too much up to the metal layer 51. Such an embodiment is shown in FIG. 3, where the SOI optical structure 34 includes a metallized top layer 51. In some applications, an electrical field may need to be induced within the optical structure or a portion thereof, in which case metallization of the optical structure is required to provide an electrical contact. In some other applications, metallization can be used to conduct electrical current of an electronic device or an opto-electronic device integrated onto the SOI structure or mounted on top thereof. The metallized top layer may for example be embodied by gold deposition on top of a thin film of chromium or titanium used as an adhesive layer. Metal from the metallized layer 51 attenuates the optical mode propagating in the optical structure when the fraction of the evanescent field of the guided mode reaching the metal layer is too large. It has been found by the inventors that in some embodiments, in order to isolate SOI optical circuits from excess loss due to metal absorption, a thick cladding, for example about 1 μm, is desired between the silicon layer 40 and the metallized layer 51. However, a thick first cladding layer of 1.5 μm of silicon oxide was found to degrade the performance of a MMI quadrature as shown in FIG. 4. While the phase difference between the outputs of a non-clad sample (A) is close to the theoretical value of 90 degrees, it is about 7 degrees off for samples having a silicon oxide cladding (B and C). The provision of a second cladding layer 50 is made of a different material than the first cladding layer has been found to provide the desired optical isolation while allowing a suitable optical performance of the device.

In accordance with another embodiment of the invention, the second cladding layer 50 is designed so that its thickness and mechanical properties reduce stresses in the optical structure 34, for example by compensating for stress inducing forces imposed by the mismatch between the first cladding layer 48 and the silicon layer 40. In this embodiment, the second cladding layer 50 is preferably made of a material having a coefficient of thermal expansion substantially the same as the coefficient of thermal expansion of silicon. The material should also be non-absorbing at the wavelength of operation.

For both embodiments described above, it has been found that when using silicon dioxide as a first cladding layer 48, silicon nitride (Si₃N₄) can successfully serve as a material of choice for the second cladding layer 50. Other materials could however be used in other embodiments of the invention, providing either optical isolation, reduced stresses or both.

In one embodiment of the invention, a double cladding configuration using the first and second cladding layers described above can improve the performance of SOI optical structures with respect to prior art. Advantageously, the first cladding layer preserves the high index contrast with the silicon waveguide structure but can induce excessive stress as described above. The provision of an appropriate second cladding layer, such as for example a stress-controlled deposition of silicon nitride on the first cladding layer, can provide nearly no stress or even positive stress, for example if using Plasma-Enhanced Chemical Vapor Deposition (PECVD). Moreover, the thermal expansion coefficient of silicon nitride is close to the one of silicon, thus rendering the cladding layers insensitive to thermal stress. However, silicon nitride has a refractive index of 2.0 providing a decrease in the desired high index contrast with silicon. Providing a second cladding layer of silicon nitride on top of a first cladding of silicon oxide itself on top of the silicon layer allows to benefit from the advantages of both materials. The first cladding layer can be made sufficiently thin to avoid excessive impact on optical performance due to stress but thick enough to keep the high index contrast of guiding structures. The second cladding layer provides the remaining required thickness to isolate the optical structures from excess loss due to metal absorption. The silicon nitride layer can also remove part of the stress caused by the silicon oxide layer if deposited with a controlled positive stress.

Still referring to FIG. 3, one skilled in the art will readily understand that the optical structure 34 is not drawn to scale and that variations in the thicknesses of the different illustrated layers are possible and should be considered from the perspective of the desired optical and mechanical properties of the resulting structure. For the Si—SiO₂—Si—SiO₂—Si₃N₄ configuration described above, the following thickness ranges may be used as a broad guide, although these ranges and relative proportions are in no way considered limitative to the scope of the present invention:

| | | |
|---|---|---|
| Substrate layer | 50-1000 | μm |
| Insulator layer | 1-3 | μm |
| Patterned silicon layer | 100-300 | nm |
| First cladding layer | 100-300 | nm |
| Second cladding layer | 400-2000 | nm |

It will be noted that the thickness of the first cladding layer is measured from the top of the non-etched regions of the silicon layer, although portions of the first cladding layer extend lower, within the non-etched regions of the silicon layer.

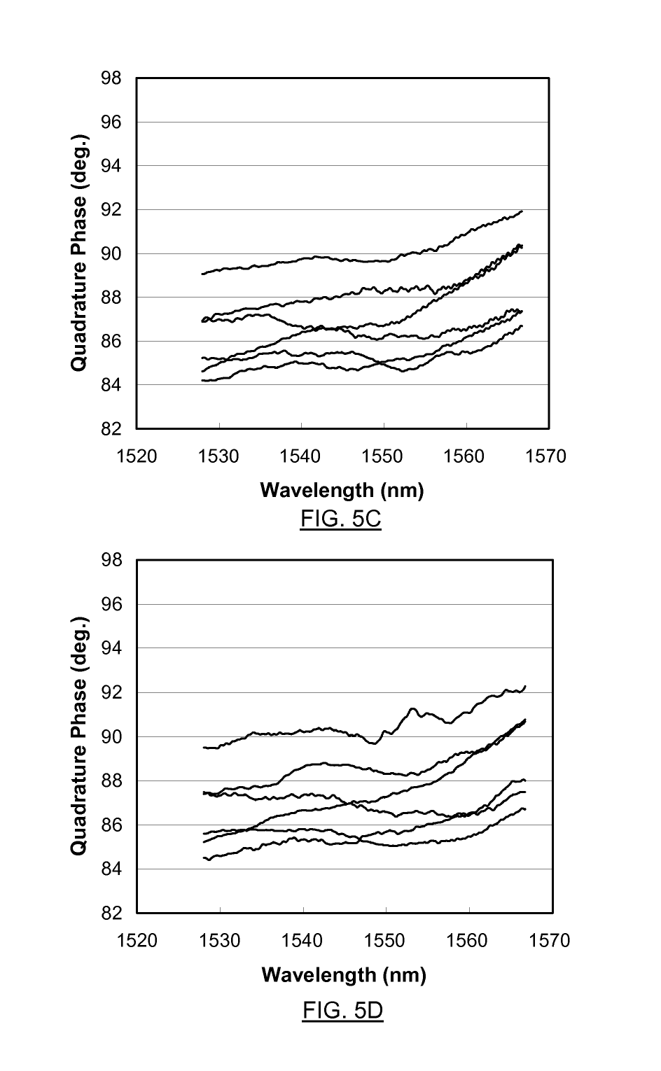

In accordance with another aspect of the invention, there is provided a method for making a SOI optical structure. FIGS. 5A to 5D, show the measured quadrature as a function of wavelength on 6 MMI samples at various steps of this process.

The method first includes providing a base which includes a silicon substrate layer, a silicon oxide insulator layer extending over the substrate layer, and a silicon layer over the insulator layer. One skilled in the art will understand that such a SOI base can be fabricated using well known techniques or obtained prefabricated from various manufacturers.

The silicon layer is then patterned to define a waveguiding structure. FIG. 5A, showing the measure quadrature phase at this stage of the process, illustrates that the quadrature phase is fairly close to the expected value.

The method next involves depositing a first cladding layer, preferably made of silicon oxide, over the silicon layer, the first cladding layer has a refractive index and a thickness providing light confinement with the waveguiding structure. In the illustrated embodiment, a thin layer of 200 nm of silicon oxide was deposited and the measured quadrature (FIG. 5B) is shown to decrease of few degrees, i.e. less than what was observed for a thick cladding of 1.5 μm.

A second cladding layer is then deposited over the first cladding layer. The second cladding layer optically isolates the waveguiding structure and has a thickness and mechanical properties reducing compressive stresses in the first cladding layer.

In the illustrated embodiment, this was performed in two steps for illustrative purposes. A layer of 400 nm of silicon nitride was first deposited and caused a slight increase of the quadrature phase towards the original values (FIG. 5C). Another layer of 400 nm was then deposited and again a slight increase of the quadrature phase values was observed (FIG. 5D). The overall two-material cladding therefore provides the desired characteristics of optical isolation while not causing strong perturbation to the optical functionality.

The depositing of the cladding layers may be performed by an appropriate process, such as for example Plasma-Enhanced Chemical Vapor Deposition, reactive ion beam deposition (IBD), reactive sputtering and RF sputtering.

Of course, numerous modifications could be made to the embodiments described above without departing from the scope of the present invention as defined in the appended claims.

1. A silicon-on-insulator optical structure, comprising, successively:
a silicon substrate layer;
a silicon oxide insulator layer;
a patterned silicon layer defining a waveguiding structure;
a first cladding layer having a refractive index and a thickness providing light confinement within the waveguiding structure;
a second cladding layer optically isolating the waveguiding structure and made of a material different than a material of the first cladding layer; and
a metallized top layer.

2. The silicon-on insulator optical structure according to claim 1, wherein the patterned silicon layer comprises a plurality of corrugations including raised and void regions, the first cladding layer filling the void regions and covering the void and raised regions.

3. The silicon-on-insulator optical structure according to claim 1, wherein the waveguiding structure defines a plurality of waveguides forming a multimode interference coupler.

4. The silicon-on-insulator optical structure according to claim 1, wherein the thickness of the first cladding layer is of a same order of magnitude as a thickness of the patterned silicon layer.

5. The silicon-on-insulator optical structure according to claim 1, wherein the material of the second cladding layer has a thickness and mechanical properties reducing stresses in the silicon-on-insulator optical structure.

6. The silicon-on-insulator optical structure according to claim 1, wherein the material of the second cladding layer has a coefficient of thermal expansion substantially the same as a coefficient of thermal expansion of silicon.

7. The silicon-on-insulator optical structure according to claim 1, wherein the first cladding layer is made of silicon oxide.

8. The silicon-on-insulator optical structure according to claim 1, wherein the second cladding layer is made of silicon nitride.

9. A silicon-on-insulator optical structure, comprising, successively:
a silicon substrate layer;
a silicon oxide insulator layer;
a patterned silicon layer defining a waveguiding structure;
a first cladding layer having a refractive index and a thickness providing light confinement within the waveguiding structure; and
a second cladding layer made of a material having a thickness and mechanical properties reducing stresses in the silicon-on-insulator optical structure.

10. The silicon-on-insulator optical structure according to claim 9, wherein the material of the second cladding layer has a coefficient of thermal expansion substantially the same as a coefficient of thermal expansion of silicon.

11. The silicon-on insulator optical structure according to claim 9, wherein the patterned silicon layer comprises a plurality of corrugations including raised and void regions, the first cladding layer filling the void regions and covering the void and raised regions.

12. The silicon-on-insulator optical structure according to claim 9, wherein the waveguiding structure defines a plurality of waveguides forming a multimode interference coupler.

13. The silicon-on-insulator optical structure according to claim 9, wherein the first cladding layer is made of silicon oxide.

14. The silicon-on-insulator optical structure according to claim 9, wherein the second cladding layer is made of silicon nitride.

15. A silicon-on-insulator optical structure, comprising, successively:
a silicon substrate layer;
a silicon oxide insulator layer;
a patterned silicon layer defining a waveguiding structure;
a silicon oxide first cladding layer providing light confinement within the waveguiding structure; and
a silicon nitride second cladding layer.

16. The silicon-on-isolator optical structure of claim 15, wherein the silicon nitride second cladding layer optically isolates the waveguiding structure

17. The silicon-on-isolator optical structure of claim 15, wherein the silicon nitride second cladding layer reduces stresses in the waveguiding structure.

18. The silicon-on-insulator optical structure according to claim 15, wherein the patterned silicon layer comprises a plurality of corrugations including raised and void regions, the first cladding layer filling the void regions and covering the void and raised regions.

19. The silicon-on-insulator optical structure according to claim 15, wherein:
the substrate layer has a thickness between about 50 to 1000 μm;
the insulator layer has a thickness between about 1 to 3 μm;
the silicon layer has a thickness between about 100 to 300 nm;
the first cladding layer has a thickness between about 100 to 300 nm; and
the second cladding layer has a thickness between about 400 to 2000 nm.

20. The silicon-on-insulator optical structure according to claim 15, wherein the waveguiding structure defines a plurality of waveguides forming a multimode interference coupler.

21. A method for making a silicon-on-insulator optical structure, comprising:
a) providing a base comprising, successively, a silicon substrate layer, a silicon oxide insulator layer and a silicon top layer over;
b) patterning the silicon layer to define a waveguiding structure;
c) depositing a first cladding layer over the patterned silicon layer, the first cladding layer having a refractive index and a thickness providing light confinement within the waveguiding structure; and
d) depositing a second cladding layer over the first cladding layer, the second cladding layer optically isolating the waveguiding structure and having a thickness and mechanical properties reducing compressive stresses in said silicon-on-insulator optical structure.

22. The method according to claim 21, wherein the depositing of steps c) and d) comprises using a plasma-enhanced chemical vapor deposition process.

23. The method according to claim 21, wherein the first cladding layer is made of silicon oxide.

24. The method according to claim 21, wherein the second cladding layer is made of silicon nitride.

25. The method according to claim 21, wherein:
the substrate layer has a thickness between about 50 to 1000 μm;
the insulator layer has a thickness between about 1 to 3 μm;
the silicon layer has a thickness between about 100 to 300 nnm;
the first cladding layer has a thickness between about 100 to 300 nm; and
the second cladding layer has a thickness between about 400 to 2000 nm.

26. The method according to claim 21, further comprising a providing a metallized top layer over the second cladding layer.

27. The method according to claim 21, wherein the depositing of the second cladding layer is performed with a controlled positive stress.
